(19) United States
(12) Patent Application Publication
(10) Pub. No.: US 2007/0221011 A1
(43) Pub. Date: Sep. 27, 2007

(54) Laborsaving cam wheel structure

(75) Inventors: Chih-Yuen Wang, Sinjhuang City (TW); Chia-Cheng Chen, Sinjhuang City (TW)

Correspondence Address: John G. Chupa;Law Offices of John Chupa & Associates, P.C., Suite 50, 28535 Orchard Lake Road, Farmington Hills, MI, 48334, US

(73) Assignee: JARLLYTEC CO., LTD.

(21) Appl. No.: 11/545,372

(22) Filed: Oct. 10, 2006

(30) Foreign Application Priority Data
Mar. 27, 2006 (TW) 095205057

(51) Int. Cl. F16H 53/00

(52) U.S. Cl. 74/567

(57) ABSTRACT

Disclosed is a laborsaving cam wheel structure formed of a fixed member and a movable member each having two slopes spirally running in reversed directions on the respective inner side. The slopes of the fixed member are respectively abutted against the slopes of the movable member such that when the movable member is biased relative to the movable member, the peak ends of the slopes of the movable member are moved along the slopes of the fixed member toward the root ends of the slopes of the fixed member.

### BACKGROUND OF THE INVENTION

1. Field of the Invention

The present invention relates a cam wheel structure and more particularly, to a laborsaving cam wheel structure for use in a hinge structure.

2. Description of the Related Art

Many products that we use frequently have a hinge structure that allows turning of two coupled members relative to each other. For example, a door uses a hinge structure so that the user can turn the door panel relative to the doorframe to open/close the access. There are many mobile electronic products using a hinge structure. For example, a notebook computer, electronic dictionary or mobile video disk player uses a hinge structure for allowing the cover member (which carries a LCD display panel on the inner side) to be turned relative to the base member between an open position and a close position.

A hinge structure for the aforesaid application uses two interference members, for example, friction members or cam wheel members for causing a torsional or friction force upon rotation of the movable member relative to the fixed member so that the cover member of the mobile electronic product can be positively positioned in the desired angle relative to the base member.

A hinge structure may be used with a spring member. The spring member imparts a force to facilitate opening of the movable member relative to the fixed member so that the user can open the movable member from the fixed member with less effort. However, conventional hinge structures having this function commonly have a complicated design, resulting in a complicated installation procedure.

### SUMMARY OF THE INVENTION

The present invention has been accomplished under the circumstances in view. According to one aspect of the present invention, the laborsaving cam wheel structure comprises a fixed member and a movable member biasable relative to the fixed member. The fixed member has a circular center axle hole and two slopes spirally running on an inner side thereof around the circular center axle hole in reversed directions. The slopes of the fixed member each have a peak end and a root end. The peak end of one of the slopes of the fixed member is abutted to the root end of the other of the slopes of the fixed member, defining therewith an elevation difference. The movable member is abutted against the inner side of the fixed member, having a non-circular center mounting hole and two slopes spirally running on an inner side thereof around the non-circular center mounting hole in reversed directions and respectively abutted against the slopes of the fixed member. The slopes of the movable member each have a peak end and a root end. The peak end of one of the slopes of the movable member is abutted to the root end of the other of the slopes of the movable member, defining therewith an elevation difference.

According to another aspect of the present invention, the non-circular center through hole of the movable member is coupled to a shaft member being inserted through the circular center through hole of the fixed member for allowing rotation of the movable member with the shaft member relative to the fixed member.

According to still another aspect of the present invention, the fixed member has a mounting portion extending from the periphery thereof, and a connecting member protruded from one side of the mounting portion for fastening to an external body.

According to still another aspect of the present invention, the connecting member of the fixed member is a pin.

### BRIEF DESCRIPTION OF THE DRAWINGS

FIG. 1 is an exploded view of a laborsaving cam wheel structure according to the present invention.

FIG. 2 is an assembly view of the present invention, showing the laborsaving cam wheel struture in a closed condition.

FIG. 3 is similar to FIG. 2 but showing the laborsaving cam wheel structure in an open condition.

### DETAILED DESCRIPTION OF THE INVENTION

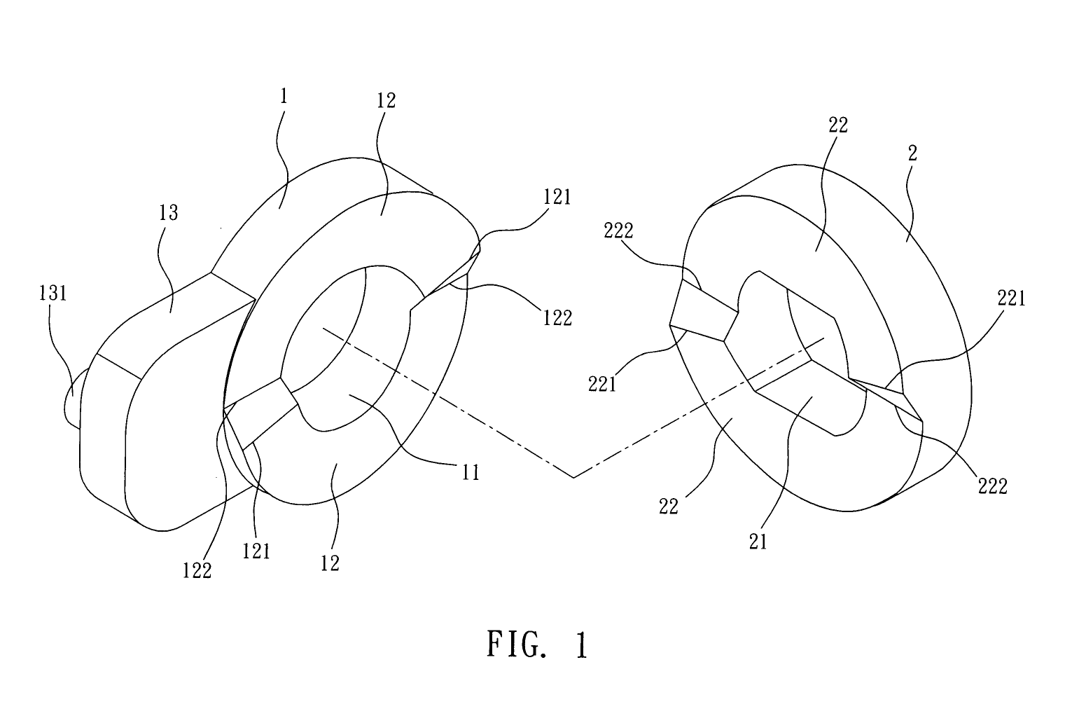

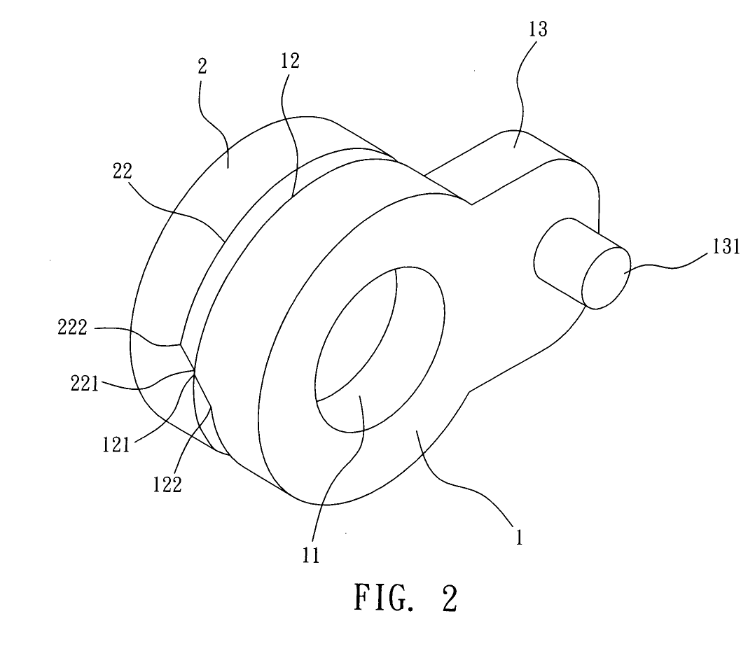

Referring to FIGS. 1 and 2, a laborsaving cam wheel structure in accordance with the present invention is shown comprised of a fixed member 1, and a movable member 2.

The fixed member 1 is an annular member having a circular center axle hole 11 for the passing of a shaft member (not shown), and two slopes 12 spirally running on one side, namely, the inner side thereof around the circular center axle hole 11 in reversed directions. The slopes 12 respectively extend through 180°, each having a peak end 121 and a root end 122. The peak end 121 of one of the slopes 12 is abutted to the root end 122 of the other of the slopes 12, defining an elevation difference. The fixed member 1 further has a mounting portion 13 radially outwardly extending from the periphery, and a connecting means, for example, a connecting pin 131 perpendicularly extended from one side, namely, the outer side of the mounting portion 13 for connection to a main member (not shown).

The movable member 2 is an annular member abutted against one sidewall of the fixed member 1, having a non-circular center mounting hole 21 coupled to the shaft member that is inserted through the circular center axle hole 11 of the fixed member 1 for synchronous rotation with the shaft member relative to the fixed member 1, and two slopes 22 spirally running on one side, namely, the inner side thereof around the non-circular center mounting hole 21 in reversed directions. The slopes 22 respectively extend through 180°, each having a peak end 221 and a root end 222. The peak end 221 of one of the slopes 22 is abutted to the root end 222 of the other of the slopes 22, defining an elevation difference.

Referring to FIG. 2, after the laborsaving cam wheel structure has been assembled (with the movable member 2 fastened to the shaft member and abutted against a spring member, for example, a spring washer or compression spring), the peak ends 121 of the slopes 12 of the fixed member 1 are respectively stopped against the peak ends 221 of the slopes 22 of the movable member 2, thereby causing the movable member 2 to compress the spring member.

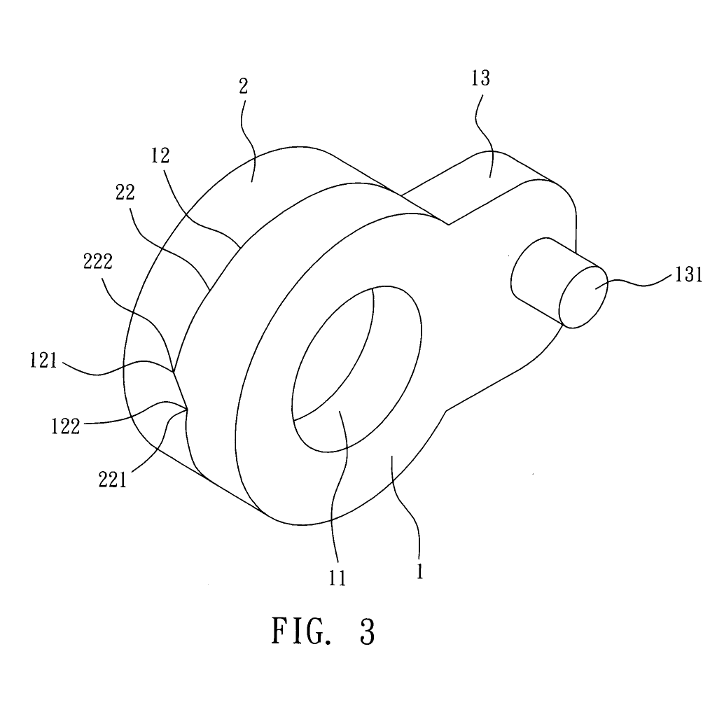

When opening the cover member, the movable member 2 is rotated with the shaft member and the cover member of the notebook computer relative to the fixed member 1 and the base member of the notebook computer, the peak ends 221 of the slopes 22 of the movable member 2 are respectively moved along the slopes 12 of the fixed member 1, and the peak ends 121 of the slopes 12 of the fixed member 1 are respectively moved along the slopes 22 of the movable member 2 toward the root ends 222 of the slopes 22 of the movable member 2, and at the same time the spring member extends axially outwards to impart a pressure to the movable member 2 against the fixed member 1. Therefore, when the user released the pressure from the cover member and base member of the notebook computer, the cover member of the notebook computer is immediately positioned in position. When turned the cover member to the maximum opening position, as shown in FIG. 3, the respective peak ends 221 and 121 are respectively stopped against the respective root ends 122 and 222.

As indicated above, the invention provides a laborsaving cam wheel structure, which has the reversely extending spiral slopes of the movable member to be respectively abutted against the reversely extending spiral slopes of the fixed member, such that the peak and root ends of the slopes of the movable member are respectively moved relative to the root and peak ends of the slopes of the fixed member when the user open or close the cover member of the notebook computer. Further, when opening the cover member of the notebook computer, the spring member imparts a force to facilitate movement of the cover member, and therefore a child or lady user can open the cover member of the notebook computer easily with less effort. Further, when closing the cover member of the notebook computer, the gravity weight of the cover member (with the LCD display panel) facilitates the closing action of the cover member.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A laborsaving cam wheel structure comprising:
a fixed member, said fixed member having a circular center axle hole and two slopes spirally running on an inner side thereof around said circular center axle hole in reversed directions, the slopes of said fixed member each having a peak end and a root end, the peak end of one of the slopes of said fixed member being abutted to the root end of the other of the slopes of said fixed member and defining therewith an elevation difference; and
a movable member abutted against the inner side of said fixed member, said movable member having a non-circular center mounting hole, and two slopes spirally running on an inner side thereof around said non-circular center mounting hole in reversed directions and respectively abutted against the slopes of said fixed member, the slopes of said movable member each having a peak end and a root end, the peak end of one of the slopes of said movable member being abutted to the root end of the other of the slopes of said movable member and defining therewith an elevation difference.

2. The laborsaving cam wheel structure as claimed in claim 1, wherein the non-circular center through hole of said movable member is coupled to a shaft member being inserted through the circular center through hole of said fixed member for allowing rotation of said movable member with said shaft member relative to said fixed member.

3. The laborsaving cam wheel structure as claimed in claim 1, wherein said fixed member has a mounting portion extending from the periphery thereof and a connecting member protruded from one side of said mounting portion for fastening to an external body.

4. The laborsaving cam wheel structure as claimed in claim 3, wherein said connecting member is a pin.
